(19) United States
(12) Patent Application Publication
(10) Pub. No.: US 2010/0254052 A1
(43) Pub. Date: Oct. 7, 2010

(54) STATIC ELECTRICITY COUNTERMEASURE COMPONENT AND METHOD FOR MANUFACTURING THE STATIC ELECTRICITY COUNTERMEASURE COMPONENT

(76) Inventors: Hidenori Katsumura, Hyogo (JP); Hideaki Tokunaga, Osaka (JP); Muneyuki Sawada, Osaka (JP)

Correspondence Address: MCDERMOTT WILL & EMERY LLP, 600 13TH STREET, NW, WASHINGTON, DC, 20005-3096, US

(21) Appl. No.: 12/679,161

(22) PCT Filed: Nov. 20, 2008
(86) PCT No.: PCT/JP2008/003406

§ 371 Date: Mar. 19, 2010

(30) Foreign Application Priority Data
Nov. 27, 2007 (JP) 2007-305411
Dec. 7, 2007 (JP) 2007-316900

(51) Int. Cl. H02H 9/04; H02H 99/00

(52) U.S. Cl. 361/56; 29/592.1; 29/875

(57) ABSTRACT

An electrostatic discharge (ESD) protector includes a ceramic body having a cavity provided therein, and two discharge electrodes facing each other across the cavity. The discharge electrodes are made of metal containing more than 80 wt. % of tungsten. The discharge electrodes contain not more than 2.0 atomic % of tungsten bonded to oxygen to a total amount of tungsten contained in the discharge electrodes. This ESD protector does not cause a short-circuiting even upon having high-voltage static electricity applied to the discharge electrodes repetitively, thus having high reliability.

### TECHNICAL FIELD

The present invention relates to an electrostatic discharge (ESD) protector for absorbing static electricity.

### BACKGROUND ART

In recent years, in order to satisfy the demands for electronic devices, such as mobile phones, having a small size and a more sophisticated function, IC has been further miniaturized and highly integrated, and had its withstanding voltage reduced accordingly. Thus, the IC is broken or operates abnormally even due to a surge, such as a static electricity discharge surge, having small energy that is generated when, e.g. a human body contacts a terminal of an electronic device.

As a countermeasure, an electrostatic discharge (ESD) protector is connected between a ground and a wiring allowing static electricity entering thereto so as to prevent a high voltage to be applied to the IC. The ESD protector has a characteristic to have a large resistance value preventing electricity from flowing through the ESD protector in a normal status, and to have a small resistance value allowing electricity to flow through the ESD protector when a high voltage, such as static electricity, is applied to the ESD protector. A zener diode, a multilayer chip varistor, and a gap surge absorber are known as the ESD protector having the above characteristic.

Patent Documents 1 and 2 disclose a conventional ESD protector, a gap surge absorber. The gap surge absorber includes a ceramic body having a cavity, a pair of discharge electrodes embedded in the ceramic body, and terminal electrodes connected to the discharge electrodes. The discharge electrodes surface each other across the cavity. The discharge electrodes open between the electrodes. When a high voltage, such as static electricity, is applied to the ESD protector, the voltage causes a discharging in the cavity between the discharge electrodes, thereby causing a current to flow.

The gap surge absorber generally has a smaller parasitic capacitance value than other ESD protectors, such as the zener diode and the multilayer chip varistor. Upon having a large capacitance value, an ESD protector connected to a signal line deteriorates a quality of a signal having a high frequency, thus preferably having a small parasitic capacitance value. Thus, the gap surge absorber can be connected to such a signal line. The cavity having the discharging occurring therein contain nothing but air, and hence, does not cause the surge absorber to break even when static electricity of a high voltage is applied, thus being advantageous against the other ESD protectors.

The pair of discharge electrodes is exposed to the cavity with a predetermined interval between the electrodes. A temperature in the cavity may reach a high temperature, e.g. higher than 2500° C., due to the discharging of static electricity. The static electricity repetitively applied to the surge absorber may melt the discharge electrodes to cause a short-circuiting.

Patent Document 1: JP1-102884A

Patent Document 2: JP11-265808A

### SUMMARY OF THE INVENTION

An electrostatic discharge (ESD) protector includes a ceramic body having a cavity provided therein, and two discharge electrodes facing each other across the cavity. The discharge electrodes are made of metal containing more than 80 wt. % of tungsten. The discharge electrodes contain not more than 2.0 atomic % of tungsten bonded to oxygen to a total amount of tungsten contained in the discharge electrodes.

This ESD protector does not cause a short-circuiting even upon having high-voltage static electricity applied to the discharge electrodes repetitively, thus having high reliability.

### BRIEF DESCRIPTION OF THE DRAWINGS

FIG. 1A is a perspective view of an electrostatic discharge (ESD) protector according to exemplary Embodiment 1 of the present invention.

FIG. 1B is a cross-sectional view of the ESD protector at line 1B-1B shown in FIG. 1A the line 1B-1B.

FIG. 2A is a cross-sectional view of the ESD protector for illustrating a method for manufacturing the ESD protector according to Embodiment 1.

FIG. 2B is a cross-sectional view of the ESD protector for illustrating the method for manufacturing the ESD protector according to Embodiment 1.

FIG. 2C is a cross-sectional view of the ESD protector for illustrating the method for manufacturing the ESD protector according to Embodiment 1.

FIG. 2D is a cross-sectional view of the ESD protector for illustrating the method for manufacturing the ESD protector according to Embodiment 1.

FIG. 2E is a cross-sectional view of the ESD protector for illustrating the method for manufacturing the ESD protector according to Embodiment 1.

FIG. 3A is a top view of the ESD protector for illustrating another method for manufacturing the ESD protector according to Embodiment 1.

FIG. 3B is a cross-sectional view of the ESD protector at line 3B-3B shown in FIG. 3A.

FIG. 4 is a cross-sectional view of the ESD protector for illustrating still another method for manufacturing the ESD protector according to Embodiment 1.

FIG. 5 is a test circuit diagram for executing an electrostatic discharge test of the ESD protector according to Embodiment 1.

FIG. 6 illustrates a voltage in the electrostatic discharge test of the ESD protector according to Embodiment 1.

FIG. 7 illustrates material of discharge electrodes of the ESD protector according to Embodiment 1.

FIG. 8 illustrates resin paste of a resin layer of the ESD protector according to Embodiment 1.

FIG. 9 illustrates the size of a cavity and an area at which the discharge electrodes of the ESD protector facing each other according to Embodiment 1.

FIG. 10A illustrates characteristics of the ESD protector according to Embodiment 1.

FIG. 10B illustrates characteristics of the ESD protector according to Embodiment 1.

FIG. 11A illustrates characteristic of an ESD protector according to Exemplary Embodiment 2 of the invention.

FIG. 11B illustrates characteristic of the ESD protector according to Embodiment 2.

FIG. 12 illustrates a relation between a voltage of a static electricity pulse applied to the ESD protector and a suppressed peak voltage according to Embodiment 2.

### REFERENCE NUMERALS

101 Ceramic Body
102 Cavity
103 Discharge. Electrode (First Discharge Electrode)
104 Discharge Electrode (Second Discharge Electrode)
105 Terminal Electrode (First Terminal Electrode)
106 Terminal Electrode (Second Terminal Electrode)
111 Surge Absorber
301 Green Sheet (First Green Sheet)
302 Metal Layer (First Metal Layer)
303 Resin Layer
303C Resin Bead
303D Resin Paste
304 Green Sheet (Third Green Sheet)
305 Green Sheet (Fourth Green Sheet)
306 Metal Layer (Second Metal Layer)
307 Green Sheet (Second Green Sheet)
308 Unsintered Layered Structure
310 Green Sheet (Third Green Sheet)
310E Opening
311 Unsintered Layered Structure
312 Unsintered Layered Structure

### DETAILED DESCRIPTION OF PREFERRED EMBODIMENTS

### Exemplary Embodiment 1

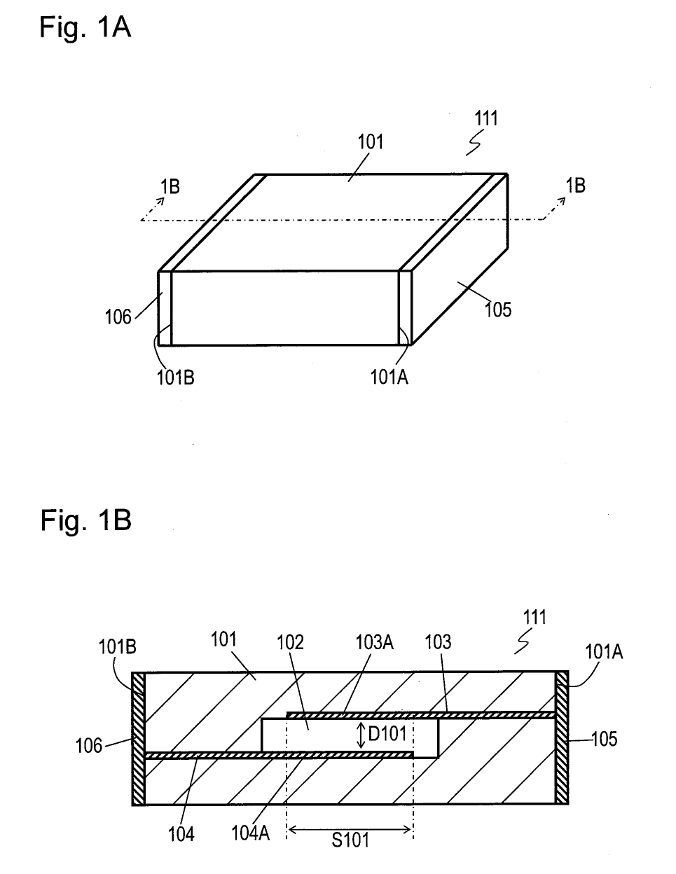

FIG. 1A is a perspective view of ESD protector 111 according to exemplary Embodiment 1 of the present invention. FIG. 1B is a cross-sectional view of electrostatic discharge (ESD) protector 111 at line 1B-1B shown in FIG. 1A. ESD protector 111 includes ceramic body 101, discharge electrodes 103 and 104 embedded in ceramic body 101, and terminal electrodes 105 and 106 connected to discharge electrodes 103 and 104, respectively. Terminal electrodes 105 and 106 are provided at ends 101A and 101B of ceramic body 101 opposite to each other, respectively. Ceramic body 101 has cavity 102 provided therein. Discharge electrodes 103 and 104 are exposed to cavity 102 and face each other across cavity 102 with a predetermined distance D101 between the electrodes. That is, discharge electrodes 103 and 104 face each other across cavity 102.

Ceramic body 101 is preferably made of ceramic insulating material mainly containing at least one ceramic composition selected from alumina, forsterite, steatite, mullite, and cordierite. These insulating materials have a low relative permittivity not larger than 15 and can reduce a parasitic capacitance value between discharge electrodes 103 and 104.

Discharge electrodes 103 and 104 are made of metal containing not less than 80% by weight of tungsten. Not larger than 1.8 atomic % of the total amount of the tungsten is bonded to oxygen. The amount of tungsten bonded to oxygen is preferably 0 atomic % of the total amount of tungsten, but actually, can be larger higher than 0 atomic %. Each of portions 103A and 104A of discharge electrodes 103 and 104 facing each other has an area ranging from 0.01 mm² to 1.0 mm². Distance D101 between portion 103A and 104A of discharge electrodes 103 and 104 range from 5 μm to 16 μm.

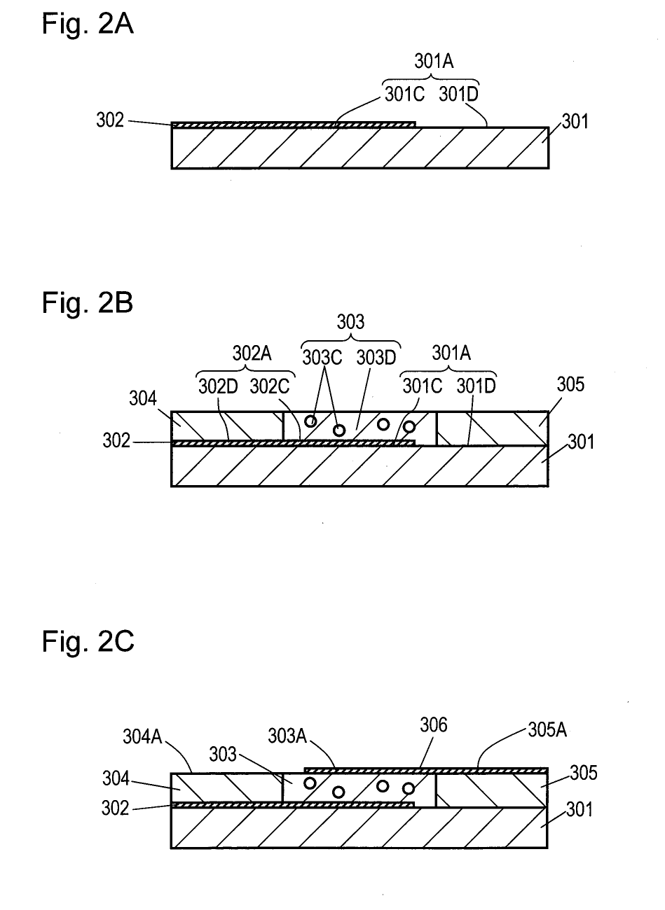

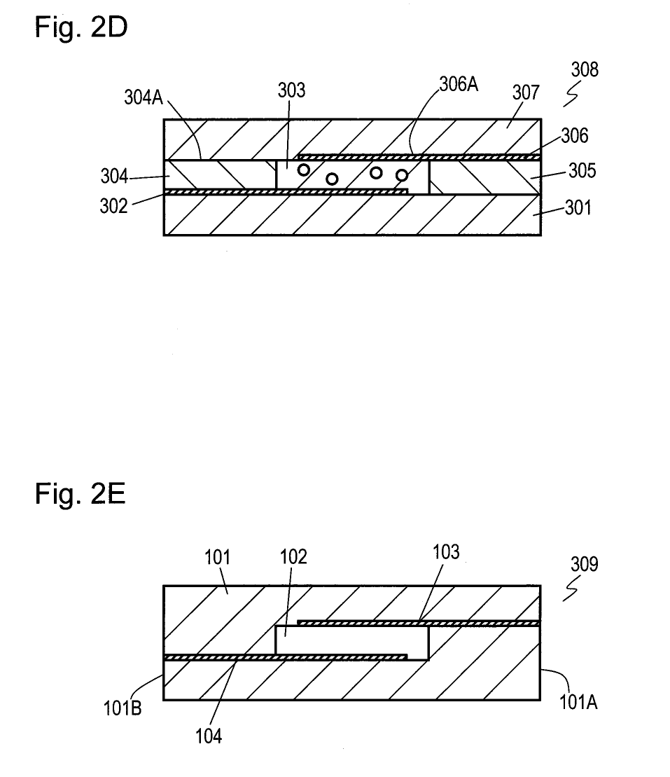

A method for manufacturing ESD protector 111 will be described below. FIGS. 2A to 2E are cross-sectional views of ESD protector 111 for illustrating the method for manufacturing ESD protector 111.

First, as shown in FIG. 2A, green sheet 301 having a thickness of about 50 μm and made of ceramic insulating material is produced with ceramic paste by a doctor blade method. Then, as shown in FIG. 2A, metal layer 302 is formed by a screen printing on portion 301C of upper surface 301A of green sheet 301 while exposing portion 301D of upper surface 301A of green sheet 301.

Next, as shown in FIG. 2B, resin paste is applied onto portion 302C of upper surface 302A of metal layer 302 to form resin layer 303 while exposing portion 302D of upper surface 302A of metal layer 302. The resin paste forming resin layer 303 contains solid resin beads 303C and resin paste 303D. As shown in FIG. 2B, green sheet 304 made of ceramic paste of ceramic insulating material is formed on portion 302D of upper surface 302A of metal layer 302. Green sheet 305 made of ceramic paste of ceramic insulating material is formed on portion 301D of upper surface 301A of green sheet 301.

Next, as shown in FIG. 2C, metal layer 306 is formed with conductive paste by a screen printing on upper surface 303A of resin layer 303 and on upper surface 305A of green sheet 305 while exposing upper surface 304A of green sheet 304.

Next, as shown in FIG. 2D, green sheet 307 is formed on upper surface 304A of green sheet 304 and on upper surface 306A of metal layer 306 with ceramic paste of ceramic insulating material, thereby providing unsintered layered structure 308.

Next, unsintered layered structure 308 is cut and divided into plural chips. The chips of unsintered layered structure 308 are sintered in mixture atmosphere made of nitrogen and not less than 0.8 vol. % of hydrogen. While unsintered layered structure 308 is sintered, hydrogen reduces oxide on surfaces of metal layers 302 and 306. This sintering, as shown in FIG. 2E, provides sintered layered structure 309 that includes ceramic body 101 composed of green sheets 301, 304, 305, and 307 and discharge electrodes 103 and 104 composed of metal layers 302 and 306. This sintering volatilizes resin layer 303 to form cavity 102 in ceramic body 101. This exposes discharge electrodes 103 and 104 to cavity 102 and allows electrodes 103 and 104 to face each other with predetermined distance D101 between the electrodes. The green sheets are designed to allow ceramic body 101 after the sintering to have an overall size of 1.6 mm by 0.8 mm by 0.8 mm, and expose discharge electrodes 103 and 104 to ends 101A and 101B of ceramic body 101 opposite to each other.

Finally, as shown in FIG. 1B, copper paste is applied onto ends 101A and 101B of ceramic body 101 to contact discharge electrodes 103 and 104, and then, is baked in nitrogen atmosphere at 800° C., thereby forming terminal electrodes 105 and 106.

In the above manufacturing method, the ceramic paste for forming green sheets 301 and 307 is prepared by mixing powders of the above-described ceramic composition, binder resin, and plasticizer with solvent. The resin paste for forming resin layer 303 is prepared by kneading solid resin bead 303C and resin paste 303D. Resin bead 303C is an acrylic bead. Resin paste 303D is acrylic resin. Acrylic resin is decomposed at a low temperature more easily than other resins, and prevents ceramic body 101 from having defects around cavity 102. Instead of the acrylic resin, the resin paste may be made of another resin that is easily decomposed at a low temperature.

The conductive paste forming metal layers 302 and 306 is made of metal containing more than 80 wt. % of tungsten.

The ceramic paste for forming green sheets 304 and 305 is prepared by mixing ceramic composition powder, binder resin, and plasticizer with solvent, similarly to the ceramic paste forming green sheets 301 and 307. However, the ceramic paste for forming green sheets 304 and 305 contains the binder resin at a more content rate than that of the ceramic paste for forming green sheets 301 and 307. This arrangement prevents green sheets 301, 304, 305, and 307 constituting ceramic body 1 from delaminating. Resin layer 303 and green sheets 304 and 305 may be formed in any order to provide the same effects.

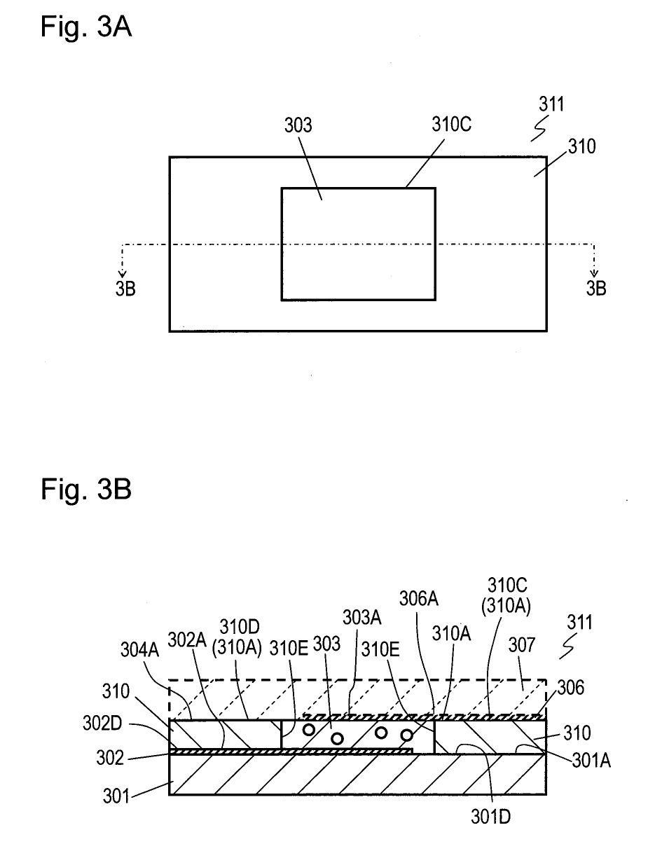

FIG. 3A is a top view of ESD protector 111 for illustrating another method for manufacturing ESD protector 111, and shows unsintered layered structure 311 including single green sheet 310. FIG. 3B is a cross-sectional view of unsintered layered structure 311 at line 3B-3B. In FIGS. 3A and 3B, components identical to those shown in FIGS. 2A to 2E are denoted by the same reference numerals, and their description will be omitted. Unsintered layered structure 311 includes green sheet 310 instead of green sheets 304 and 305 of unsintered layered structure 308 shown in FIG. 2D. Green sheet 310 has opening 310E therein in which resin layer 303 is placed. Green sheet 310 is made of the same material as green sheets 304 and 305, and is formed on portion 302D of upper surface 302A of metal layer 302 and on portion 301D of upper surface 301A of green sheet 301. Metal layer 306 is formed on upper surface 303A of resin layer 303 and on portion 310C of upper surface 310A of green sheet 310 directly above portion 301D of upper surface 301A of green sheet 301. Green sheet 307 is formed on upper surface 306A of metal layer 306 and on portion 310D of upper surface 310A of green sheet 310 directly above portion 302D of upper surface 302A of metal layer 302. The ceramic paste for forming green sheet 310 contains binder resin at a higher content rate than that of the ceramic paste for forming green sheets 301 and 307. This composition prevents green sheets 301, 307, and 310 constituting ceramic body 1 from delaminating.

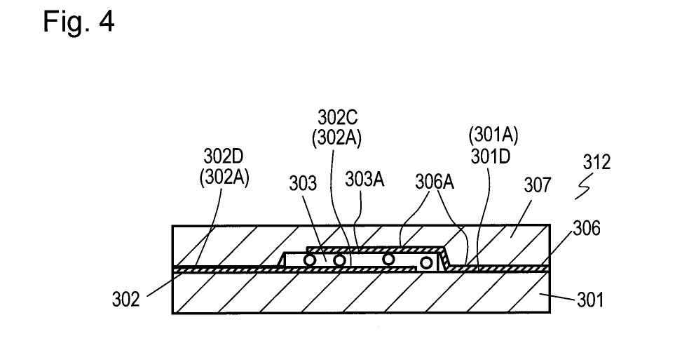

A multilayered structure without green sheets 304 and 305 may cause undulation in resin layer 303 to prevent the conductive paste for forming metal layer 306 from being precisely applied by the screen printing, and produce a defect in ceramic body 1 after the sintering. Green sheets 304 and 305 can eliminate the undulation, hence allowing the conductive paste to be applied precisely, hence to form metal layer 306. FIG. 4 is a cross-sectional view of ESD protector 111 for illustrating still another method for manufacturing ESD protector 111 and shows another unsintered layered structure 312 according to Embodiment 1. In FIG. 4, components identical to those shown in FIGS. 2A to 2E are denoted by the same reference numerals, and their description will be omitted. In the case that cavity 102 is thin and resin layer 303 for forming cavity 102 is thin, green sheets 304 and 305 are not necessarily formed. In this case, metal layer 306 is formed on upper surface 303A of resin layer 303 and on portion 301D of upper surface 301A of green sheet 301. Green sheet 307 is formed on portion 302C of upper surface 302A of metal layer 302 and on upper surface 306A of metal layer 306.

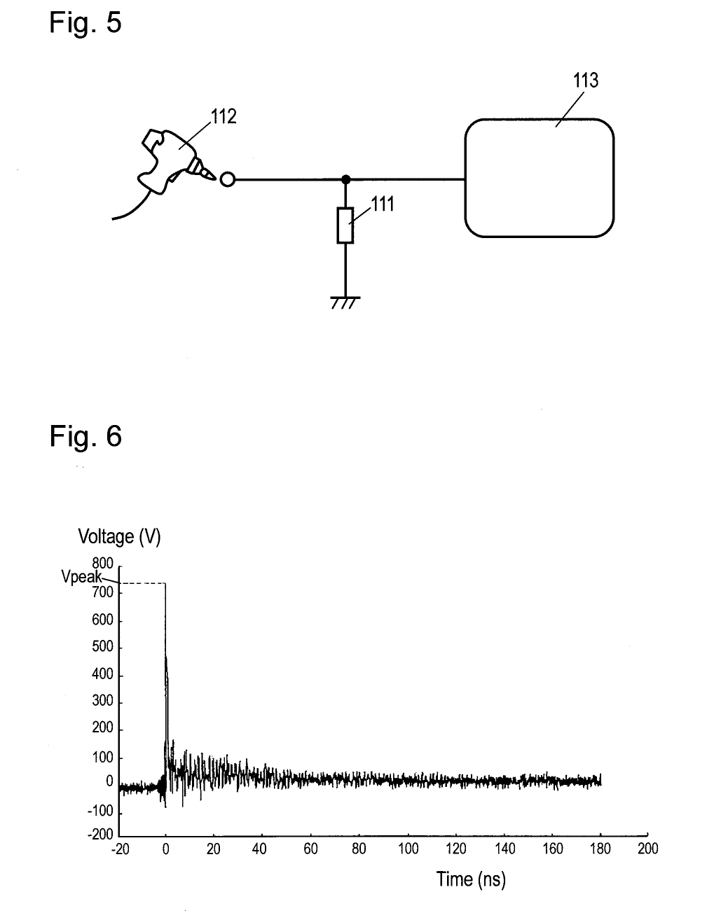

Next, samples of ESD protector 111 were prepared. These samples were subjected to a static electricity discharge test based on the IEC-6100-4-2 standard (4 to 20 kV-150 pF-330Q). FIG. 5 illustrates a test circuit for the static electricity discharge test of the ESD protector. Digital oscilloscope 113 is connected in parallel to ESD protector 111. A static electricity pulse was directly applied from ESD gun 112 to ESD protector 111. When the static electricity pulse causes a discharge between discharge electrodes 103 and 104 across cavity 102 of ESD protector 111, i.e., when the ESD protector 111 operates, most of a current produced by the static electricity flows to a ground. A voltage causing the discharge and producing conductivity between discharge electrodes 103 and 104 is defined as a discharge-starting voltage of ESD protector 111. Digital oscilloscope 113 can be used to observe the voltage suppressed by ESD protector 111. The observed voltage is shown in FIG. 6. Immediately after the static electricity pulse is applied, a high peak voltage is observed, and immediately attenuates. This peak voltage is a suppressed peak voltage. Specifically, ESD protector 111 suppresses the voltage of the applied static electricity pulse to the suppressed peak voltage. The lower the suppressed peak voltage is, the more easily the ESD protector causes discharge and the ESD protector is superior.

In order to evaluate the status of the surfaces of discharge electrodes 103 and 104, the upper surface of ceramic body 101 was polished so as to expose surfaces of discharge electrodes 103 and 104. The exposed surfaces of discharge electrodes 103 and 104 were measured by an X-ray photoelectron spectroscopy (XPS) analysis with an X-ray source of Al-Kα, photoelectron extraction angle of 45 degrees, an analysis area of 100 μmΦ, and a voltage of 25.9 W. The amount of tungsten bonded to oxygen and the amount of tungsten not bonded to oxygen on the surfaces of discharge electrodes 103 and 104 were detected. The amount of oxide of tungsten was calculated based on the detected amounts.

The above-described static electricity discharge test was also performed under conditions of 8 kV-150 pF-330Ω. A static electricity pulse was repetitively applied until the number of times the pulse was applied reached 1000. Then, a change in the insulation resistance of ESD protector 111 was measured.

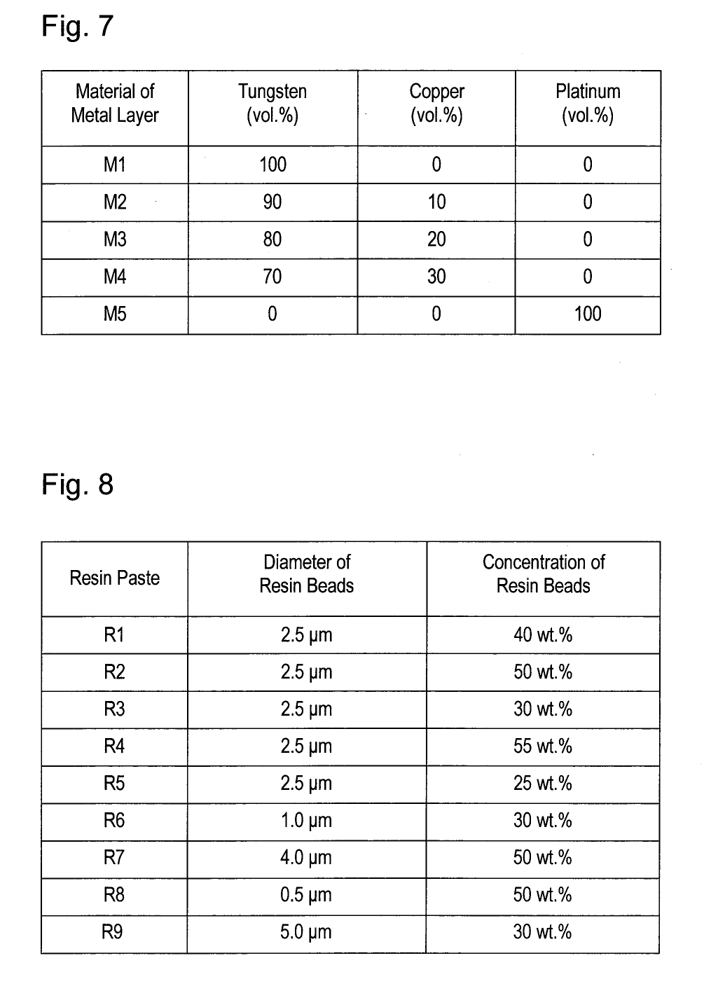

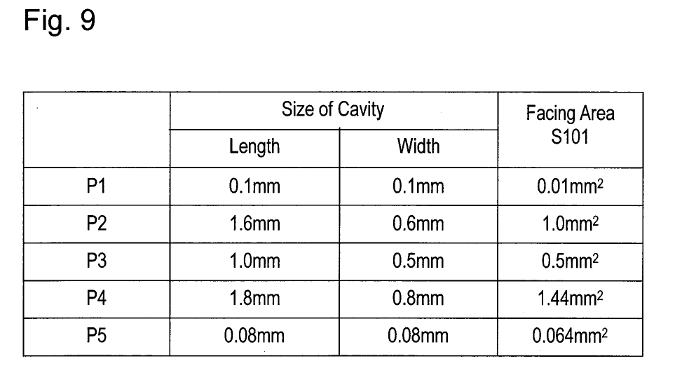

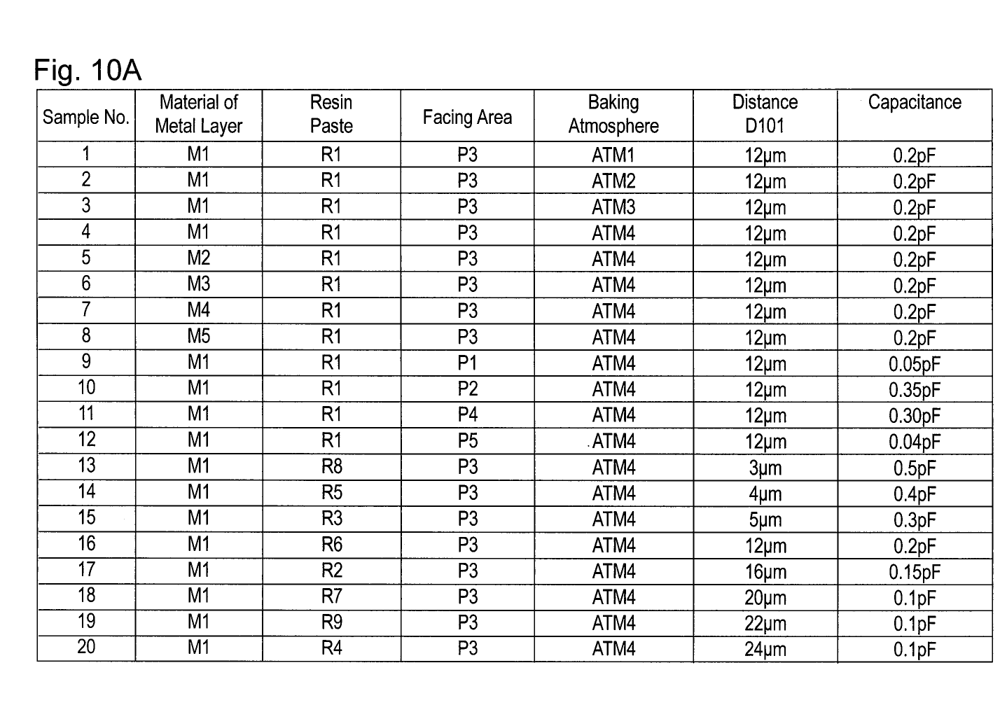

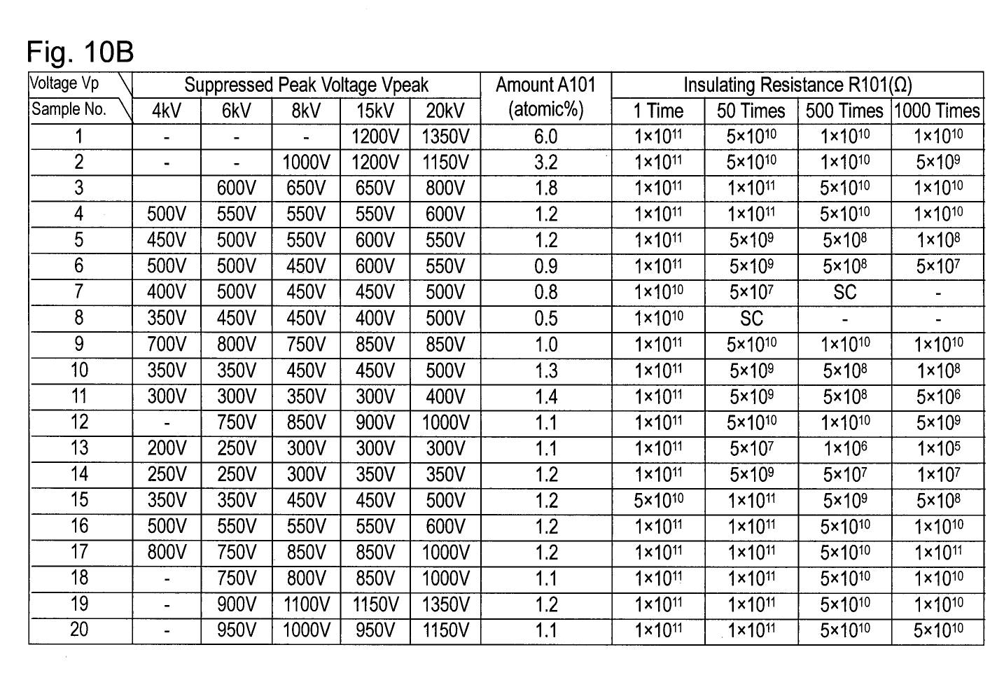

FIG. 7 illustrates materials M1 to M5 of metal layers 302 and 306 (discharge electrodes 103 and 104) of samples of ESD protector 111. FIG. 8 illustrates diameters and content rates of the resin beads in resin pastes R1 to R9 of resin layer 303 for forming cavity 102 of the samples of ESD protector 111. The resin beads were made of acrylic. FIG. 9 illustrates combinations P1 to P5 of lengths and widths of cavities 102 of the samples of ESD protector 111 and area S101 in which discharge electrodes 103 and 104 face each other. FIGS. 10A and 10B illustrate characteristics of the samples including discharge electrodes 103 and 104 shown in FIGS. 7 to 9 and the resin paste.

FIGS. 10A and 10B illustrate, regarding the samples, sintering atmospheres ATM101 to ATM104 for sintering unsintered layered structure 308, the height of cavity 102, i.e., distance D101 (μm) between discharge electrodes 103 and 104, capacitance C101 (pF) between discharge electrodes 103 and 104, suppressed peak voltage Vpeak (V) corresponding to voltage Vp (kV) of the applied static electricity pulse, amount A101 (atomic %) of metal oxide at the surface of discharge electrodes 103 and 104, and insulation resistance R101 (Ω) between discharge electrodes 103 and 104 to the number of times static electricity discharge (ESD) is executed. The indication “SC” shown at insulation resistance R101 represents a short-circuiting between discharge electrodes 103 and 104. Samples of unsintered layered structures 308 were maintained in baking atmospheres ATM101 to ATM104 at 1250° C. for 2 hours, and then, were sintered. Baking atmosphere ATM104 contains 100 vol. % of nitrogen and 0% of hydrogen. Baking atmosphere ATM102 contains 99.9 vol. % of nitrogen and 0.1 vol. % of hydrogen. Baking atmosphere ATM103 contains 99.8 vol. % of nitrogen and 0.2 vol. % of hydrogen. Baking atmosphere ATM104 contains 99.0 vol. % of nitrogen and 1.0 vol. % of hydrogen.

Samples 1 to 4 are different from one another only in the baking atmosphere. In sample 1 sintered in baking atmosphere ATM101 containing 100% of nitrogen and 0% of hydrogen, although an electrostatic discharge occurred between electrodes 103 and 104, the surfaces of electrodes 103 and 104 had 6 atomic % of tungsten bonded to oxygen to the total amount of tungsten. The oxide existing on the surfaces of electrodes 103 and 104 increases a resistance on the surfaces, accordingly suppress the electrostatic discharge. Thus, sample 1 exhibited a high discharge-starting voltage of 8 kV and a very high suppressed peak voltage due to the static electricity of a high voltage applied. In samples 3 and 4 sintered in the baking atmosphere containing more than 0.2 vol. % of hydrogen, the amount of tungsten bonded to oxygen at the surfaces of discharge electrodes 103 and 104 was lower than 2 atomic %, and the discharge-starting voltage and the suppressed peak voltage were low, thus providing superior characteristics. The baking atmosphere contains a lot of hydrogen reduces the composition pf the ceramic body during the sintering, and loses the insulation property, thus changing into semiconductor. Depending on the type of the ceramic composition and the sintering temperature, the upper limit of the concentration of hydrogen in the baking atmosphere changes. Thus, the upper limit may be determined appropriately.

Samples 5 to 8 are different from one another only in the materials of discharge electrodes 103 and 104. Tungsten mixed with copper forms alloy having a low melting point and providing electrodes 103 and 104 with high conductivity. In the case that samples 5 and 6 for which the metal constituting discharge electrodes 103 and 104 contained not more than 80 wt. % of tungsten, no short-circuiting occurred between electrodes 103 and 104 even when ESD was executed 1000 times. In sample 7 including electrodes 103 and 104 containing 70 wt. % of tungsten, short-circuiting occurred when the ESD was executed 500 times. In sample 8 including electrodes 103 and 104 made of platinum, a short-circuiting occurred when the ESD occurred only 50 times. The ESD raises a temperature of cavity 102 and electrodes 103 and 104 to 2500 to 3000° C. Upon having a melting point equal to or higher than this temperature, electrodes 103 and 104 are prevented from short-circuiting even when the ESD is executed repetitively.

Samples 9 to 12 are different from one another only in facing area S101 at which discharge electrodes 103 and 104 face each other. Samples having large facing area S101 causes the ESD executed repetitively, having a small insulation resistance. Sample having small facing area S101 have a suppressed peak voltage and a high discharge-starting voltage.

Sample 11 having facing area S101 larger than 1.0 mm² had a low insulation resistance after 1000 times of the ESD on the order of 10⁶Ω but had no short-circuiting. Thus, facing area S101 is preferably not larger than 1.0 mm². Sample 12 having facing area S101 smaller than 0.01 mm² had no ESD by static electricity of 4 kV. Thus, facing area S101 is preferably not smaller than 0.01 mm².

Samples 13 to 20 are different from each other in the resin paste for forming cavity 102. If the diameter of the resin beads contained in the resin paste and the content rate of the resin beads are different, the height of cavity 102, i.e., distance D101 between electrodes 103 and 104, changes. Smaller distance D101 reduces the insulation resistance due to the ESD executed repetitively. Samples 13 and 14 having distance D101 shorter than 5 μm had a low insulation resistance ranging from 1×10⁵Ω to 1×10⁸Ω although no short-circuiting occurred between electrodes 103 and 104. On the other hand, larger distance D101 suppresses the ESD and provides a higher suppressed peak voltage. Samples 19 and 20 having distance D101 more than 20 μm had a high suppressed peak voltage higher than 900V for the static electricity of 6 kV. The height of cavity 102, i.e., distance D101 between electrodes 103 and 104, ranges preferably from 5 to 20 μm. Sample 18 having distance D101 more than 16 μm had no ESD at static electricity of 4 kV although having a low suppressed peak voltage. Thus, distance D101 between electrodes 103 and 104 ranges preferably from 5 to 16 μm.

Ceramic body 101 can have another circuit as to further lower the suppressed peak voltage. For example, ceramic body 101 can have a fine line patterned to form an inductor. Alternatively, the surface of ceramic body 101 can be coated or printed with resistance paste to form a resistance.

Hydrogen contained in the baking atmosphere for sintering unsintered layered structure 308 reduces the oxide on the surface of discharge electrodes 103 and 104. Instead of hydrogen, the baking atmosphere can contain other reducible gas, such as carbon monoxide or sulfurous gas, for reducing the oxide on the surface of discharge electrodes 103 and 104 (metal layers 302 and 306).

### Exemplary Embodiment 2

An electrostatic (ESD) protector according to Exemplary Embodiment 2 has the same structure as ESD protector 111 shown in FIGS. 1A and 1B according to Embodiment 1. In the ESD protector according to Embodiment 2, discharge electrodes 103 and 104 are made of metal containing more than 80 wt. % of tungsten. The amount of tungsten bonded to oxygen to the total amount of tungsten is not higher than 2.0 atomic %. The amount of tungsten bonded to oxygen to the total amount of tungsten is preferably 0 atomic % but actually, is often more than 0 atomic %.

The ESD protector according to Embodiment 2 can be manufactured by the method shown in FIGS. 2A to 2E for manufacturing the ESD protector 111 according to Embodiment 1. In the ESD protector according to Embodiment 2, unsintered layered structure 308 shown in FIG. 2D is sintered in nitrogen atmosphere containing reducible gas for reducing the oxide on the surface of metal layers 302 and 306. Hydrogen is used as the reducible gas according to Embodiment 2, but other reducible gases can be used.

A green sheet is designed to provide ceramic body 101 with an overall size of 2.0 mm by 1.2 mm by 0.8 mm after the sintering.

Next, samples of the ESD protector according to Embodiment 2 were prepared. Similarly to Embodiment 1, these samples were subjected to a static electricity discharge test in the electrostatic test circuit shown in FIG. 5 based on the IEC-6100-4-2 standard (4 to 20 kV-150 pF-330Ω). Similarly to Embodiment 1, on the surfaces of discharge electrodes 103 and 104, the amount of tungsten bonded to oxygen and the amount of tungsten not bonded to oxygen were detected and the amount of tungsten oxide was calculated based on these detected amounts.

The above static electricity discharge test was performed under conditions of 8 kV-150 pF-330Ω. A static electricity pulse was repetitively applied until the number of times the pulse was applied reached 1000. Then, a change in the insulation resistance of the ESD protector according to Embodiment 2 was measured.

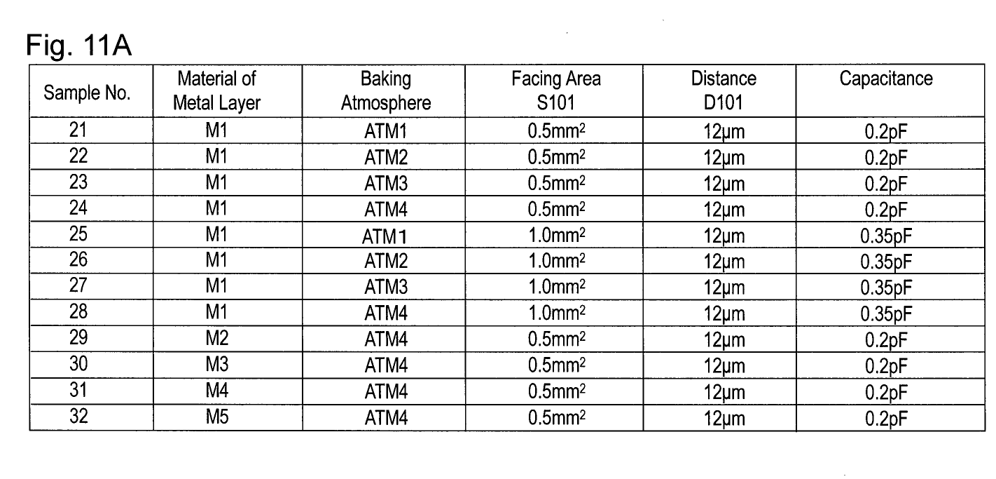

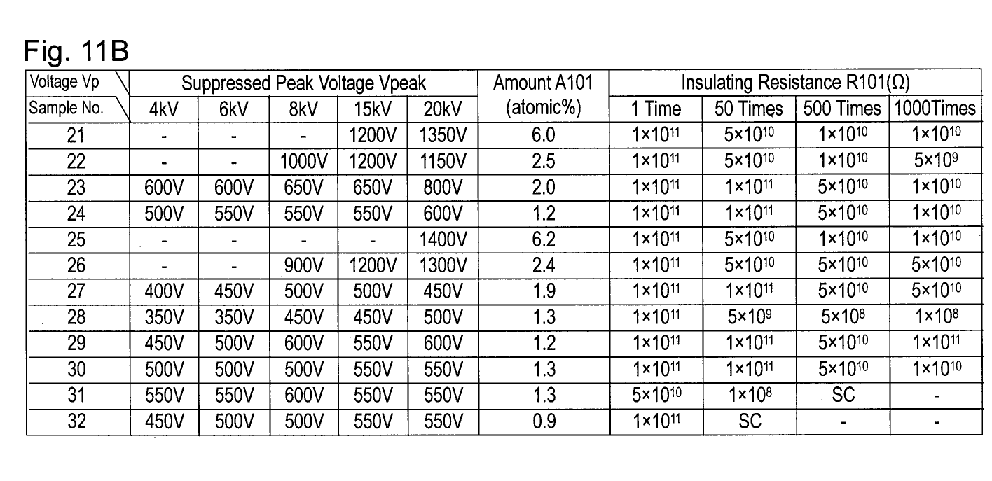

FIG. 11 illustrates characteristics of the samples of the ESD protector according to Embodiment 2 that were made of materials M1 to M5 shown in FIG. 7 and sintered in different baking atmospheres.

FIG. 11 illustrates baking atmospheres ATM101 to ATM104 for sintering unsintered layered structure 308, facing area S101 (mm2) at which electrodes 103 and 104 face each other, the height of cavity 102, i.e., distance D101 (μm) between discharge electrodes 103 and 104, capacitance C101 (pF) between discharge electrodes 103 and 104, suppressed peak voltage Vpeak (V) to voltage Vp (kV) of the applied static electricity pulse, amount A101 (atomic %) of metal oxide on the surfaces of discharge electrodes 103 and 104, and insulation resistance R101 (Ω) between discharge electrodes 103 and 104 to the number of static electricity discharge (ESD) executed repetitively. The indication “SC” shown as insulation resistance R101 represents short-circuiting between discharge electrodes 103 and 104. Samples of unsintered layered structures 308 were maintained in baking atmospheres ATM101 to ATM104 at 1250° C. for 2 hours and were sintered. Baking atmosphere ATM104 contains 100 vol. % of nitrogen 100% and 0% of hydrogen. Baking atmosphere ATM102 contains 99.9 vol. % of nitrogen and 0.1 vol. % of hydrogen. Baking atmosphere ATM103 contains 99.8 vol. % of nitrogen and 0.2 vol. % of hydrogen. Baking atmosphere ATM104 contains 99.0 vol. % of nitrogen and 1.0 vol. % of hydrogen.

Samples 21 to 24 are different from one another only in the baking atmosphere. In sample 21 sintered in baking atmosphere ATM101 containing 100% of nitrogen and 0% of hydrogen, although an ESD occurs between electrodes 103 and 104, the surfaces of electrodes 103 and 104 have tungsten bonded to oxygen in an amount as high as 6 atomic % to the total amount of tungsten. An X-ray photoelectron spectroscopy (XPS) analysis merely analyzes a part of the thickness of electrodes 103 and 104 by only a few nanometers from the surfaces of electrodes 103 and 104 and thus has substantially no influence on the resistance of the entire electrode. Oxide existing on the surfaces of electrodes 103 and 104 increases a resistance on the surfaces, thus suppressing the ESD. Thus, sample 21 has a high discharge-starting voltage of 15 kV and a very high suppressed peak voltage to static electricity of a high voltage. In samples 23 and 24 sintered in the baking atmosphere containing not less than 0.2 vol. % of hydrogen, the amount of tungsten bonded to oxygen on the surfaces of discharge electrodes 103 and 104 is lower than 2 atomic %, and the discharge-starting voltage and the suppressed peak voltage are low, thus providing superior characteristic. The upper limit of the concentration of hydrogen in the baking atmosphere can be any value so long as ceramic is not reduced during sintering.

Samples 25 to 28 are identical to samples 21 to 24, respectively, except for that samples 25 to 28 have a large facing area of 1.0 mm². Similarly to samples 21 to 24, in samples 25 to 28, the amount of tungsten bonded to oxygen on the surfaces of discharge electrodes 103 and 104 is lower than 2 atomic %, and the discharge-starting voltage and the suppressed peak voltage are low, thus providing superior characteristics.

Samples 29 to 32 are different only in the materials of discharge electrodes 103 and 104. Tungsten mixed with copper forms alloy having a low melting point and improve conductivity of electrodes 103 and 104. In samples 29 and 30 for which the metal constituting discharge electrodes 103 and 104 contains not less than 80 wt. % of tungsten, no short-circuiting occurred between electrodes 103 and 104 even when the ESD is repeated 1000 times. In sample 31 including electrodes 103 and 104 containing 70 wt. % of tungsten, short-circuiting occurred when ESD was repeated 500 times. In sample 32 including electrodes 103 and 104 made of platinum, short-circuit occurred when ESD was repeated only 50 times. The ESD increases the temperature of cavity 102 and electrodes 103 and 104 to a high temperature ranging from 2500 to 3000° C. If discharge electrodes 103 and 104 have a melting point not lower than this temperature, electrodes 103 and 104 are free from short circuit even when ESD is repeated.

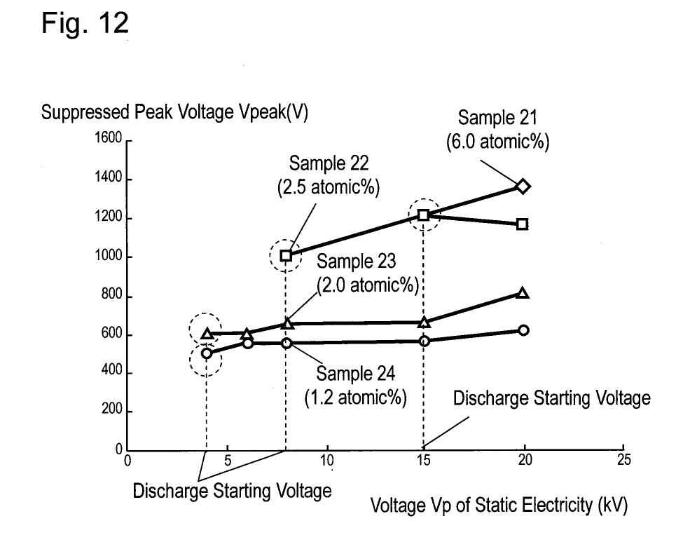

FIG. 12 illustrates suppressed peak voltage Vpeak to voltage Vp of the static electricity pulse applied to samples 21 to 24. As shown in FIG. 12, the discharge-starting voltage and the suppressed peak voltage change depending on the ratio of the tungsten bonded to oxygen obtained by measuring the surfaces of discharge electrodes 103 and 104 by the XPS analysis. As shown in FIG. 12, samples 23 and 24 in which the amount of the tungsten bonded to oxygen was 2.0 atomic % and 1.2 atomic %, respectively had a low discharge-starting voltage and a low suppressed peak voltage. In view of reaction of the oxide on the surfaces of electrodes 103 and 104, not more than 2.0 atomic % of tungsten bonded to oxygen presumably allows the ESD protector to provide the same effects.

In Embodiments 1 and 2, the terms, such as “upper surface” and “directly above” indicating directions indicate relative directions depending on a relative position of components, such as the green sheets, the metal layers, and the resin layer, of the ESD protector, and do not indicate absolute directions, such as a vertical direction.

### INDUSTRIAL APPLICABILITY

An electrostatic discharge protector according to the present invention does not cause a short-circuiting even upon having high-voltage static electricity applied to the discharge electrodes repetitively, thus having high reliability, and is useful for various devices requiring static electricity countermeasure.

1. An electrostatic discharge (ESD) protector comprising:
a ceramic body having a cavity provided therein;
a first discharge electrode embedded in the ceramic body and having a portion exposed to the cavity; and
a second discharge electrode embedded in the ceramic body and having a portion exposed to the cavity, the portion of the second discharge electrode facing the portion of the first discharge electrode with a predetermined distance between the first discharge electrode and second discharge electrode, wherein
the first discharge electrode and the second discharge electrode are made of metal containing more than 80 wt. % of tungsten, and
the first discharge electrode and the second discharge electrode contain not more than 2.0 atomic % of tungsten bonded to oxygen to a total amount of tungsten contained in the first discharge electrode and the second discharge electrode.

2. The ESD protector according to claim 1, wherein
the first discharge electrode and the second discharge electrode contain not more than 1.8 atomic % of tungsten bonded to oxygen to the total amount of tungsten,
an area of the portion of the first discharge electrode and an area of the portion of the second discharge electrode range from 0.01 mm² to 1.0 mm², and
the predetermined distance ranges from 5 μm to 16 μm.

3. The ESD protector according to claim 1, further comprising:
a first terminal electrode connected to the first discharge electrode; and
a second terminal electrode connected to the second discharge electrode.

4. The ESD protector according to claim 1, wherein the ceramic body contains at least one ceramic composition selected from alumina, forsterite, steatite, mullite, and cordierite.

5. A method for manufacturing an electrostatic (ESD) protector, comprising:
forming an unsintered layered structure, said forming the unsintered layered structure comprising:
forming a first metal layer including tungsten of 80 weight % or more on an upper surface of a first green sheet made of ceramic insulating material;
forming a resin layer containing resin beads and resin paste on an upper surface of the first metal layer;
forming a second metal layer containing 80 wt. % of tungsten on an upper surface of the resin layer; and
forming a second green sheet made of ceramic insulating material on an upper surface of the second metal layer; and
sintering the unsintered layered structure in nitrogen atmosphere containing reducible gas, wherein
said sintering the unsintered layered structure comprises:
sintering the first green sheet and the second green sheet and volatilizing the resin paste to form a ceramic body having a cavity provided therein,
sintering the first metal layer to form a first discharge electrode layer having a portion exposed to the cavity, and
sintering the second metal layer to form a second discharge electrode layer having a portion exposed to the cavity, the portion of the second discharge electrode facing the portion of the first discharge electrode with a predetermined distance between the first discharge electrode and the second discharge electrode.

6. The method according to 5, wherein the nitrogen atmosphere contains not less than 0.2 vol. % of the reducible gas.

7. The method according to 5, wherein
an area of the portion of the first discharge electrode and an area of the portion of the second discharge electrode range from 0.01 mm² to 1.0 mm², and
the predetermined distance ranges from 5 μm to 16 μm.

8. The method according to claim 5, wherein the reducible gas is hydrogen.

9. The method according to claim 5, wherein
said forming the first metal layer on the upper surface of the first green sheet comprises, while exposing a first portion of the upper surface of the first green sheet, forming the first metal layer on a second portion of the upper surface of the first green sheet,
said forming the resin layer on the upper surface of the first metal layer comprises, while exposing a first portion of the upper surface of the first metal layer, forming the resin layer on a second portion of the upper surface of the first metal layer,
said forming the unsintered layered structure further comprises:
forming a third green sheet made of ceramic insulating material on the first portion of the upper surface of the first metal layer, and
forming a fourth green sheet made of ceramic insulating material on the first portion of the upper surface of the first green sheet,
said forming the second metal layer on the upper surface of the resin layer comprises forming the second metal layer on the upper surface of the resin layer and an upper surface of the fourth green sheet, and
said forming the second green sheet on the upper surface of the second metal layer comprises forming the second green sheet on the upper surface of the second metal layer and an upper surface of the third green sheet.

10. The method according to 9, wherein
the first green sheet contains binder resin,
the second green sheet contains binder resin,
the third green sheet contains binder resin at a content rate higher than a content rate of the binder resin in the first green sheet and a content rate of the binder resin in the second green sheet, and
the fourth green sheet contains binder resin at a content rate higher than a content rate of the binder resin of the first green sheet and a content rate of the binder resin of the second green sheet.

11. The method according to claim 5, wherein
said forming the first metal layer on the upper surface of the first green sheet comprises, while exposing a first portion of the upper surface of the first green sheet, forming the first metal layer on a second portion of the upper surface of the first green sheet, and
said forming the resin layer on the upper surface of the first metal layer comprises, while exposing a first portion of the upper surface of the first metal layer, forming the resin layer on a second portion of the upper surface of the first metal layer,
said forming the unsintered layered structure further comprises:
providing a third green sheet having an opening therein and made of ceramic insulating material; and
forming a third green sheet on the first portion of the upper surface of the first metal layer and on the first portion of the upper surface of the first green sheet such that the resin layer is positioned in the opening,
said forming the second metal layer on the upper surface of the resin layer comprises forming the second metal layer on the upper surface of the resin layer and a first portion of an upper surface of the third green sheet, and
said forming the second green sheet on the upper surface of the second metal layer comprises forming the second green sheet on the upper surface of the second metal layer and a second portion of the upper surface of the third green sheet.

12. The method according to 11, wherein
the first green sheet contains binder resin,
the second green sheet contains binder resin, and
the third green sheet contains binder resin at a content rate higher than a content rate of the binder resin in the first green sheet and a content rate of the binder resin in the second green sheet.

13. The method according to claim 5, wherein the resin beads and the resin paste are made of acrylic resin.
